(19) United States
(12) Patent Application Publication
(10) Pub. No.: US 2013/0082543 A1
(43) Pub. Date: Apr. 4, 2013

(54) PORTABLE POWER SUPPLY

(71) Applicant: Tse-Ming Tang, Kaohsiung (TW)

(72) Inventor: Tse-Ming Tang, Kaohsiung (TW)

(21) Appl. No.: 13/457,902

(22) Filed: Apr. 27, 2012

(30) Foreign Application Priority Data
Sep. 30, 2011 (TW) 100218382

(51) Int. Cl. H02J 7/00

(52) U.S. Cl. 307/150

(57) ABSTRACT

A portable power supply is provided with a power-on light; an LED member; an LED switch electrically connected to the LED member for turning on or off the LED member; a first power socket; a USB port; a second power socket; a display for showing a voltage reading; an internal battery assembly having a plurality of rechargeable batteries; and an internal control circuit board electrically interconnecting the battery assembly and each of the power-on light, the LED switch, the first power socket, the USB port, the second power socket, and the display.

### BACKGROUND OF THE INVENTION

1. Field of the Invention

The invention relates to power supplies and more particularly to an improved portable power supply for mobile devices including mobile phones and tablet computers.

2. Description of Related Art

Mobile devices such as mobile phones and tablet computers are popular throughout the world. For example, many people have at least one mobile phone. However, how to supply electricity to a mobile phone for its normal operation in a prolonged period of time without recharging is always an issue to be discussed or solved.

One solution is for a user carrying an additional backup battery. However, its bulky size causes a great inconvenience to users especially laptop users.

Moreover, such backup batteries are designed to be used with its dedicated mobile devices. That is, a user carrying two different mobile devices may have to carry additional two different backup batteries. This requires much physical effort.

Further, such backup batteries are not capable of charging a mobile device while supplying power to the same.

Thus, the need for improvement still exists.

### SUMMARY OF THE INVENTION

It is therefore one object of the invention to provide a portable power supply comprising a power-on light; an LED member; an LED switch electrically connected to the LED member for turning on or off the LED member; a first power socket; a USB port; a second power socket; a display for showing a voltage reading; an internal battery assembly comprising a plurality of rechargeable batteries; and an internal control circuit board electrically interconnecting the battery assembly and each of the power-on light, the LED switch, the first power socket, the USB port, the second power socket, and the display.

The above and other objects, features and advantages of the invention will become apparent from the following detailed description taken with the accompanying drawings.

### BRIEF DESCRIPTION OF THE DRAWINGS

FIG. 1 is an exploded view of a portable power supply according to the invention;

FIG. 2 is a perspective view of the assembled portable power supply;

FIGS. 3, 4 and 5 are perspective views of the portable power supply attached to a mobile phone, a tablet computer and a laptop respectively;

FIG. 6 is a perspective view of the portable power supply attached to a voltage regulator; and

FIG. 7 is a perspective view of the portable power supply attached to a transformer for charging.

### DETAILED DESCRIPTION OF THE INVENTION

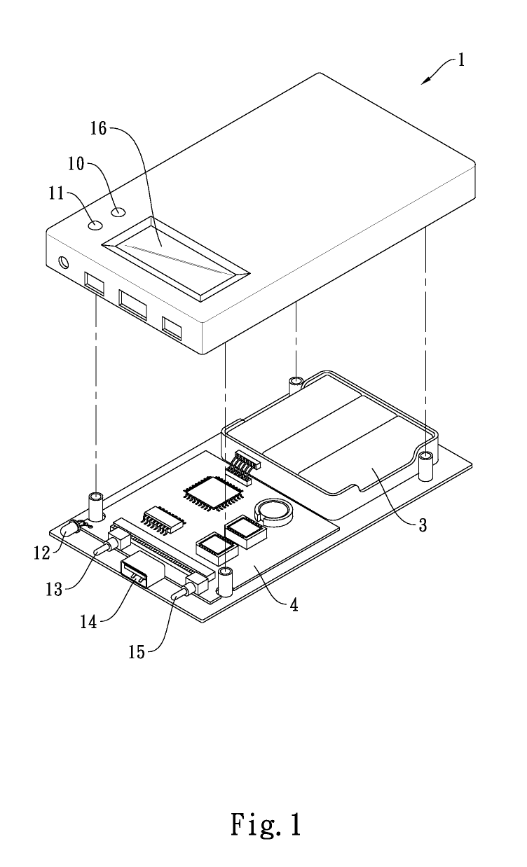

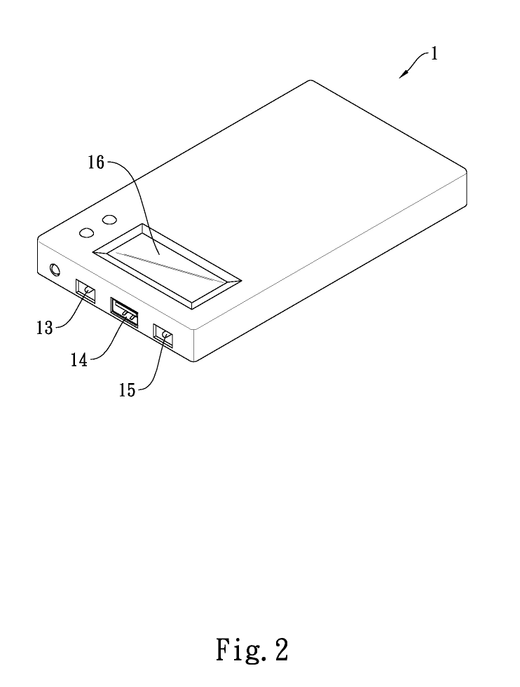

Referring to FIGS. 1 and 2, a portable power supply 1 in accordance with the invention is shown. The portable power supply 1 is shaped as a parallelepiped and comprises the following components as discussed in detail below.

A power-on light 10 and an LED (light-emitting diode) switch 11 are provided near one corner of a top. An LED member 12 is provided on a forward end aligned with both the power-on light 10 and the LED switch 11. A first power socket 13, a USB (Universal Serial Bus) port 14, and a second power socket 15 are also provided on the forward end and are aligned with the LED indicator 12. That is, the LED member 12, the first power socket 13, the USB port 14, and the second power socket 15 are provided in a spaced fashion on the front end. A display 16 is provided on the top besides the power-on light 10 and the LED switch 11. Voltage reading is shown on the display 16. A pressing of the LED switch 11 can turn on/off the LED member 12.

A battery assembly 3 is provided on a rear portion within the housing of the power supply 1 and includes three rechargeable batteries each having a capacity of 36 A. A control circuit board 4 is provided on an intermediate portion of the housing of the power supply 1 between the battery assembly 3 and the front end of the power supply 1. The control circuit board 4 is electrically connected to the components 10 to 16. Further, the control circuit board 4 is electrically connected to the battery assembly 3 so that power of the battery assembly 3 can be supplied to the control circuit board 4 and further to the components 10-16 via the control circuit board 4.

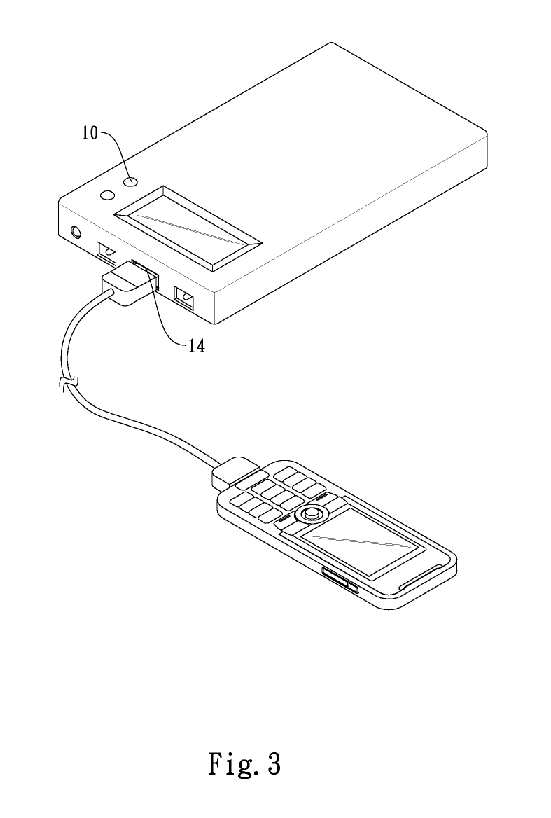

Referring to FIG. 3, in a first application the USB port 14 is electrically connected to a mobile phone for supplying power thereto.

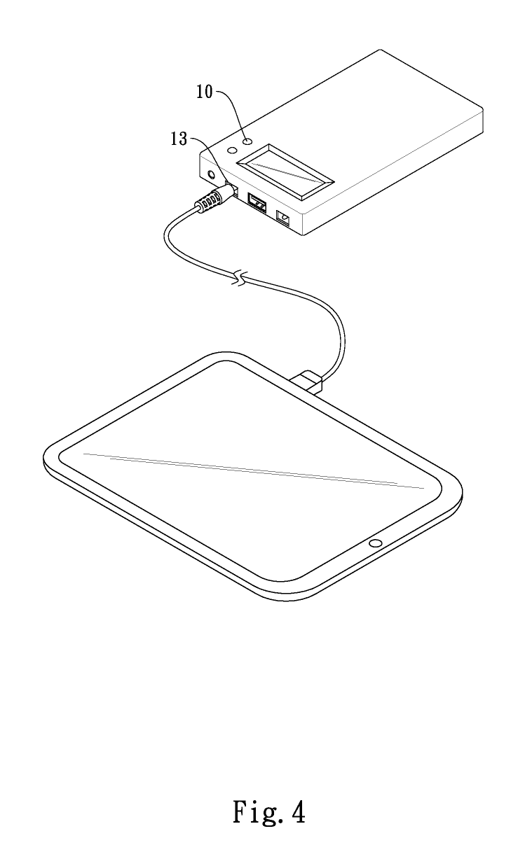

Referring to FIG. 4, in a second application the first power socket 13 is electrically connected to a tablet computer for supplying power thereto.

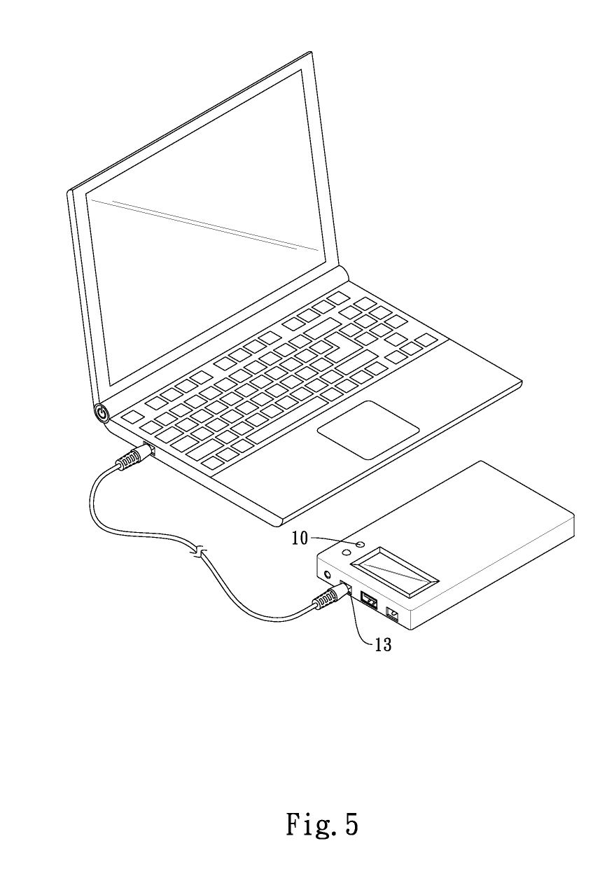

Referring to FIG. 5, in a third application the first power socket 13 is electrically connected to a laptop for supplying power thereto.

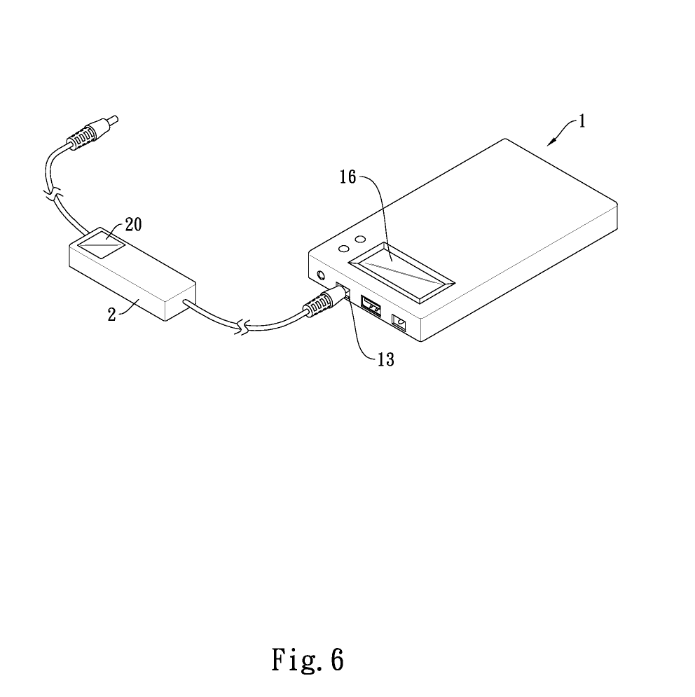

Referring to FIG. 6, a voltage regulator 2 can be provided in a predetermined portion of a cable having one end formed as a connector adapted to insert into the first power socket 13 and the other end formed as a plug. The voltage regulator 3 can perform a voltage adjustment in the range of about 1.2 DCV to 30.5 DCV. The range of the voltage being adjusted (i.e., between 1.2 DCV and 30.5 DCV) is shown on a display 20 of the voltage regulator 2. Further, the adjusted voltage is shown on the display 16.

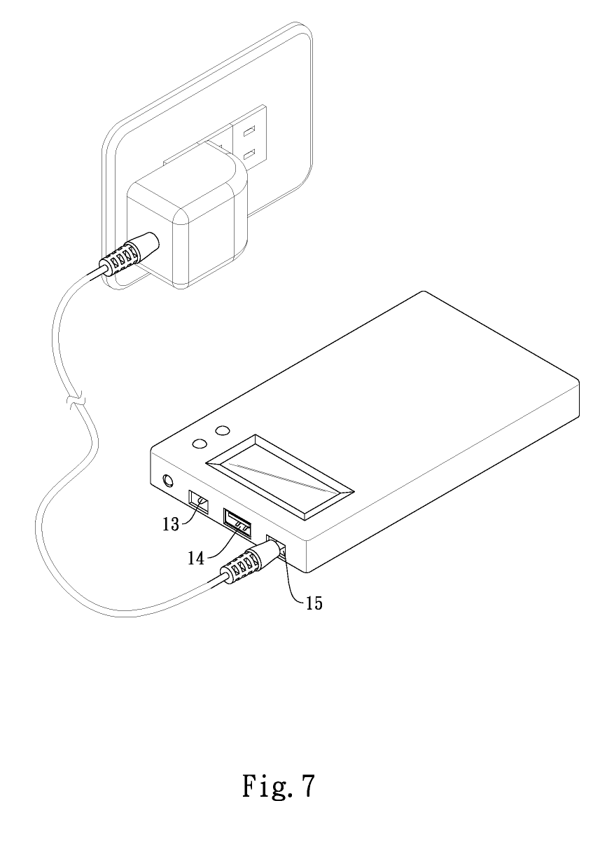

Referring to FIG. 7, a transformer (i.e., electrical adapter) (not numbered) can have one end (i.e., terminals) inserted into a wall outlet and the other end formed as a connector inserted into the first power socket 15 when the battery of the portable power supply is discharged so that household alternating current can be converted into direct current to be supplied to the portable power supply for charging. Moreover, a first mobile device (e.g., laptop) can be electrically connected to the first power socket 13 and/or a second mobile device (e.g., a mobile phone) can be electrically connected to the USB port 14 for charging while above transformer works.

While the invention has been described in terms of preferred embodiments, those skilled in the art will recognize that the invention can be practiced with modifications within the spirit and scope of the appended claims.

What is claimed is:

1. A portable power supply comprising:
a power-on light;
an LED member;
an LED (light-emitting diode) switch electrically connected to the LED member for turning on or off the LED member;
a first power socket;
a USB (Universal Serial Bus) port;
a second power socket;
a display for showing a voltage reading;
an internal battery assembly including a plurality of rechargeable batteries; and
an internal control circuit board electrically interconnecting the battery assembly and each of the power-on light, the LED switch, the first power socket, the USB port, the second power socket, and the display.

2. The portable power supply of claim 1, wherein each of the rechargeable batteries has a capacity of 36 A.

3. The portable power supply of claim 1, further comprising a voltage regulator capable of electrically connecting to the first power socket, the voltage regulator including a display member.

4. The portable power supply of claim 3, wherein the voltage regulator performs a voltage adjustment between about 1.2 DCV and 30.5 DCV.
